(19) United States
(12) Patent Application Publication
(10) Pub. No.: US 2013/0304387 A1
(43) Pub. Date: Nov. 14, 2013

(54) METHOD AND APPARATUS FOR ANALYZING GENETIC INFORMATION OF ABNORMAL TISSUE

(71) Applicant: SAMSUNG ELECTRONICS CO., LTD., Suwon-si (KR)

(72) Inventors: Jong-suk CHUNG, Hwaseong-si (KR); Tae-jin AHN, Seoul (KR); Dae-soon SON, Seoul (KR); Eun-jin LEE, Seoul (KR)

(73) Assignee: SAMSUNG ELECTRONICS CO., LTD., Suwon-si (KR)

(21) Appl. No.: 13/686,691

(22) Filed: Nov. 27, 2012

(30) Foreign Application Priority Data
May 9, 2012 (KR) 10-2012-0049275

(51) Int. Cl. G06F 17/18

(52) U.S. Cl. CPC G06F 17/18
USPC 702/19

(57) ABSTRACT

A method and apparatus for analyzing genetic information of abnormal tissue, the method and apparatus involving obtaining a first set of sequence data that includes one or more pieces of sequence data that are aligned in one or more single nucleotide polymorphism (SNP) sites from genetic samples of abnormal tissue; obtaining a second set of sequence data that includes one or more pieces of sequence data that are aligned in one or more SNP sites from genetic samples of normal tissue; analyzing, by a processing unit, a distribution of alleles in corresponding portions of the first set of sequence data and the second set of sequence data; and determining a contamination rate of a sample of a tissue by using a result of the analyzing.

### CROSS-REFERENCE TO RELATED APPLICATIONS

This application claims the benefit of Korean Patent Application No. 10-2012-0049275, filed on May 9, 2012, in the Korean Intellectual Property Office, the disclosure of which is incorporated by reference herein in its entirety.

### BACKGROUND

1. Field

The present disclosure relates to methods and apparatuses for analyzing genetic information of abnormal tissue by using a genetic sample of the abnormal tissue.

2. Description of the Related Art

After deoxyribonucleic acid (DNA) was discovered, technology for analyzing genes of an individual was developed. Accordingly, studies have been performed with the aim of analyzing a mutant genotype and researching polymorphism by using DNA technology. Among a plurality of types of polymorphism, single nucleotide polymorphism (SNP) is most frequently found in the human genome.

Human genetic elements are related to diseases of humans. Humans have different resistances, sensitivities, and degrees of severity with respect to different diseases based on the genetic elements of a particular human's own genetic makeup. In particular, the SNP is correlated with disease expression of humans, or the like, and nucleotide sequences of particular locations indicating SNP of a patient group having particular diseases are different from nucleotide sequences of the particular locations of a comparative group or a normal group. Thus, it is possible to diagnose, prescribe, and prevent diseases, based on differences between DNA sequences.

Recently, there have been many attempts by various research institutes and others in the various medical fields to diagnose, prescribe, and prevent diseases by using next generation sequencing (NGS) technology. In particular, research is being actively conducted with the aim of developing a personalized treatment via a genetic profile of a cancer patient. Still, there remains a need for new methods and apparatuses for analyzing genetic information.

### SUMMARY

Provided are methods and apparatuses for analyzing genetic information of abnormal tissue such as cancer tissue, tumor tissue, and the like.

In one aspect, the present disclosure provides a method of analyzing genetic information of abnormal tissue includes operations of obtaining one or more pieces of sequence data (e.g., nucleotides sequences or sequence “reads”) which are aligned with (encompass) one or more single nucleotide polymorphism (SNP) sites, wherein the sequences are from genetic samples of abnormal tissue and normal tissue; using a gene analyzing unit to analyze the distribution of alleles in the sequences from the abnormal and normal tissues, respectively, at each of the one or more SNP sites; and determining a contamination rate of the genetic sample of the abnormal tissue, which may be contaminated by the genetic material of the normal tissue, based on the analysis of the distribution of alleles.

According to another aspect, the disclosure provides a non-transitory computer-readable recording medium including a program recorded thereon to execute the method by using a computer.

Also provided herein is an apparatus for analyzing genetic information of abnormal tissue, which includes a data obtaining unit for obtaining one or more pieces of sequence data (e.g., nucleotide sequence or sequence “reads”), which are aligned with (encompass) one or more single nucleotide polymorphism (SNP) sites from genetic samples of abnormal tissue and normal tissue; a gene analyzing unit for analyzing the distribution of alleles in the abnormal and normal sequences, respectively, at each of the one or more SNP sites; and a contamination rate determining unit for determining a contamination rate of the genetic sample of the abnormal tissue, which may be contaminated by the genetic material of the normal tissue, based on the analysis of the distribution of alleles.

Additional aspects will be set forth in part in the description and drawings which follow and, in part, will be apparent from the description and drawings, or may be learned by practice of the presented embodiments.

### BRIEF DESCRIPTION OF THE DRAWINGS

FIG. 1 is a schematic drawing that illustrates a configuration of a genetic information analyzing apparatus;

FIG. 2A is a photomicrograph and drawing that illustrates contamination that occurs when cancer tissue is extracted from internal body tissue to which cancer cells have spread;

FIG. 2B is a drawing that illustrates characteristics of a loss of heterozygosity (LOH), which are found in a cancer cell or cancer tissue;

FIG. 3A presents sequence data including an SNP site of a genetic sample extracted from abnormal tissue (here, cancer tissue), which is obtained by a data obtaining unit;

FIG. 3B presents sequence data including an SNP site of a genetic sample extracted from normal tissue, which is obtained by the data obtaining unit;

FIG. 4 is a schematic drawing that illustrates a detailed configuration of a gene analyzing unit;

FIG. 5 is a table for analysis of allele distribution, which may be used by a probability calculating unit;

FIG. 6 is a flowchart of a method of analyzing genetic information of abnormal tissue.

### DETAILED DESCRIPTION

Reference will now be made in detail to embodiments, examples of which are illustrated in the accompanying drawings.

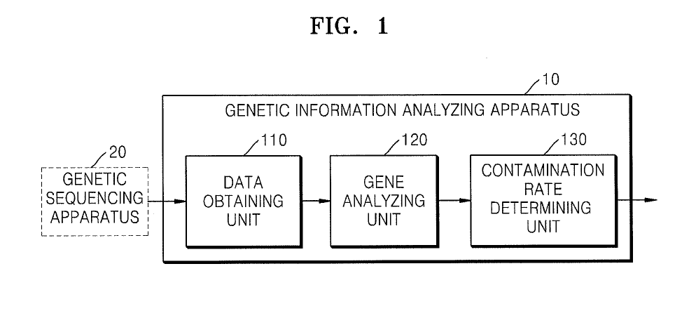

FIG. 1 illustrates a configuration of a genetic information analyzing apparatus 10, according to an embodiment of the present invention. Referring to FIG. 1, the genetic information analyzing apparatus 10 includes a data obtaining unit 110, a gene analyzing unit 120, and a contamination rate determining unit 130.

Configuration elements, such as the data obtaining unit 110, the gene analyzing unit 120, and the contamination rate determining unit 130, may, for example, correspond to a processor (e.g., computer processor, logic chip, microchip, etc). Thus, the processor may be embodied as an array of a plurality of logic gates or may be embodied as a microprocessor and a combination of memories storing programs that are executable in the microprocessor. Alternatively, according to various embodiments, the processor may be embodied as a different type of hardware.

Throughout the specification, only hardware components related to the embodiments herein are described so as to not unnecessarily obscure the embodiments herein. However, embodiments may further include general-use hardware components in addition to the hardware components shown in FIG. 1.

According to some embodiments, the genetic information analyzing apparatus 10 may correspond to any apparatus capable of performing genetic sequencing, such as, for example, a next generation sequencing (NGS) technology.

Referring to FIG. 1, the genetic information analyzing apparatus 10 is an apparatus for analyzing genetic information by obtaining the genetic information from a genetic sequencing apparatus 20 that performs genetic sequencing on genetic samples of examinees that react to a deoxyribonucleic acid (DNA) chip, such as, for example, a microarray (not shown).

In particular, the genetic information analyzing apparatus 10 analyzes genetic information of a patient having abnormal tissue, such as, for example, cancer cells, tumor cells, or the like in a patient's body. Here, abnormal tissue and normal tissue are obtained from the same type of tissue in an examinee.

When the genetic sequencing apparatus 20 performs genetic sequencing on a genetic sample of abnormal tissue, the genetic sequencing apparatus 20 perform genetic sequencing only on the genetic material from abnormal tissue in order for the sequencing to be exact. If the genetic sample is contaminated with other genetic material, errors in the analysis may occur.

However, it may be difficult to perform exact analysis because the genetic material of normal tissue may be included in a genetic sample of cancer tissue. In other words, there is a high possibility that the genetic sample of the cancer tissue is contaminated by the genetic sample of the normal tissue. Here, the sequence data obtained by using the NGS technology may correspond to read data. That is, in the present embodiment, the sequence may correspond to a read that is a nucleotide sequence piece or a nucleotide sequence fragment, which has a predetermined size.

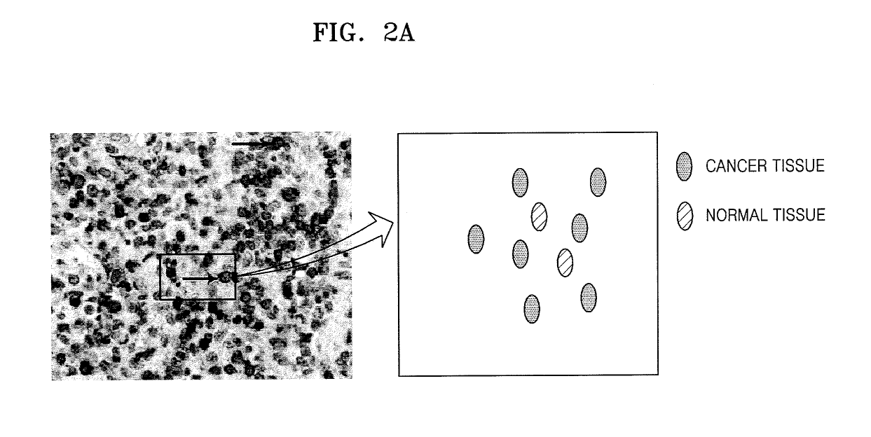

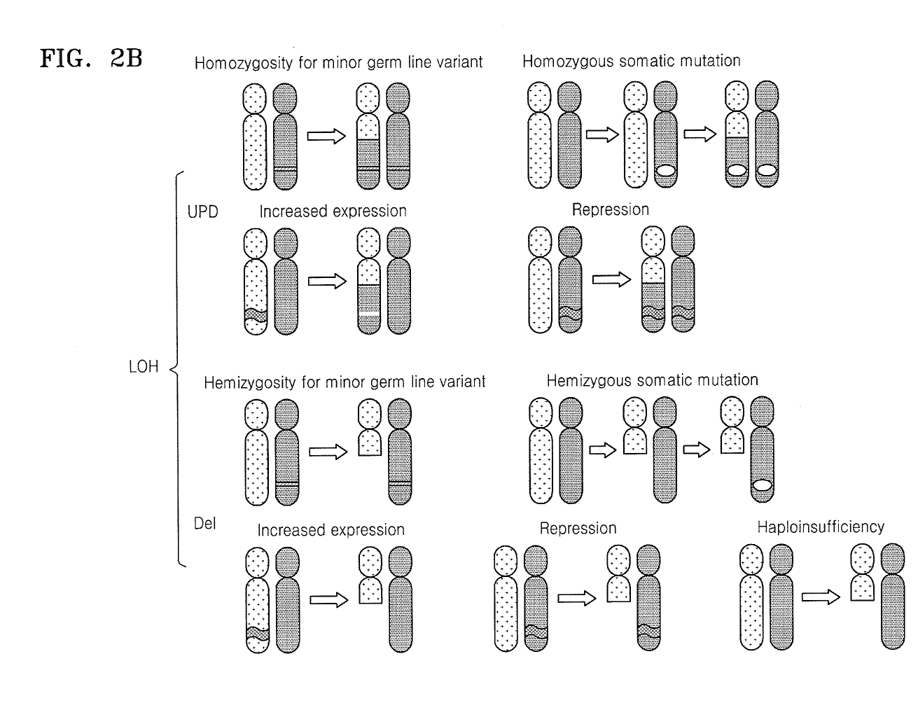

FIG. 2A illustrates a problem that occurs when cancer tissue is extracted from internal body tissue to which cancer cells have spread. Before the genetic sequencing apparatus 20 performs genetic sequencing on a genetic sample of abnormal tissue, a portion of the cancer tissue from the internal body tissue to which cancer cells have spread is extracted. During this process, there is a high probability that not only the cancer tissue, but also normal tissue, is extracted. The extraction problem may occur whether a machine extracts the tissue or a person manually extracts the tissue by using a surgical tool. FIG. 2A illustrates a tissue extraction from a cancerous site, which includes both cancerous and normal tissue.

For example, in the case of hematologic cancer or a cancer cell without a marker, it is not possible to exactly classify abnormal tissue and normal tissue and then to extract the abnormal tissue. Thus, it is not possible to analyze exact genetic information about the abnormal tissue.

Thus, in order to exactly analyze a genetic sample of abnormal tissue extracted from a cancer patient, the level of contamination in the genetic sample by genetic material of a normal cell must be determined.

It is generally known that, unlike normal tissue, loss of heterozygosity (LOH) occurs in abnormal tissue such as a cancer cell. LOH refers to the loss of a heterozygous nucleotide sequence pair, which may occur when chromosomes are imperfectly copied. For instance, when a pair of homologous chromosomes from a father and a mother is copied, one of a nucleotide sequence pair of the homologous chromosome is lost, so that only the other one is left. Alternatively, only a father's chromosome or only a mother's chromosome might be copied superiorly, resulting in a loss of one of the original nucleotide sequence pairs. In some instances, the LOH may cause the chromosome (more particularly, the gene in which the LOH arises) to lose its normal function, and the tissue containing the damaged chromosome may grow as abnormal tissue. FIG. 2B illustrates characteristics of LOH, which are found in a cancer cell or cancer tissue, according to an embodiment of the present invention. FIG. 2B illustrates various types of the LOH that occur after a pair of homologous chromosomes is copied. That is, after the pair of homologous chromosomes is copied, the various types of the LOH include, for example, deletion (Del) in which one nucleotide sequence pair of the homologous chromosomes is lost, so that only the other one is left; uniparental disomy (UPD) in which only one of the father's chromosome and the mother's chromosome is copied superiorly, and the like.

The LOH is well-known to one of ordinary skill in the art. Thus, detailed descriptions thereof will be omitted here.

Referring back to FIG. 1, the genetic information analyzing apparatus 10 analyzes the genetic sample of the abnormal tissue by using a characteristic of LOH of the abnormal tissue. Hereinafter, operations of the genetic information analyzing apparatus 10 will be described in detail.

The data obtaining unit 110 obtains one or more pieces of sequence data that are aligned in one or more single nucleotide polymorphism (SNP) sites from genetic samples of the abnormal tissue and the normal tissue. In other words, the sequences encompass the SNP site. The data obtaining unit 110 obtains sequencing results with respect to the abnormal tissue and the normal tissue, respectively, from the genetic sequencing apparatus 20. Here, as described above, the sequence data may correspond to read data.

In general, the SNP is a genetic change or genetic variation that causes a difference in a nucleotide sequence (A, T, C or G) at a specific location in a DNA nucleotide sequence, and the SNP is a type of single nucleotide variation between individuals of the single species. The SNP is a genetic element that may be related to diseases of humans. For instance, due to an SNP, humans may have different resistances, sensitiveness, and seriousness with respect to the diseases. Thus, it is possible to diagnose, prescribe, and prevent diseases, in consideration of correlation between the SNP and the diseases.

The one or more pieces of sequence data that are aligned in one or more SNP sites of the genetic samples obtained by the data obtaining unit 110 include, in one aspect, nucleotide sequence data for the same number of sequences with respect to the abnormal tissue and the normal tissue, respectively.

Also, the sequence data obtained by the data obtaining unit 110 may indicate at least one SNP site (e.g., the location of at least one SNP site) in which an allele of the abnormal tissue is referred to as homo or homozygous, and an allele of the normal tissue is referred to as hetero or heterozygous. In other words, the at least one SNP site corresponds to a site in which LOH typically occurs or has in fact occurred in the abnormal tissue.

Referring to FIG. 1, the data obtaining unit 110 obtains the one or more pieces of sequence data of the SNP sites. However, the genetic information analyzing apparatus 10, according to another embodiment, may include a separate configuration for detecting an SNP site in which an allele of abnormal tissue is called as homo and an allele of normal tissue is called as hetero.

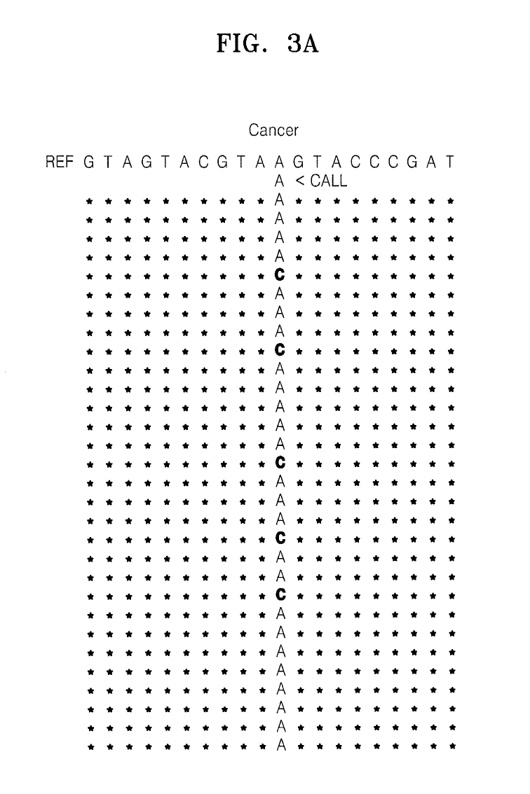

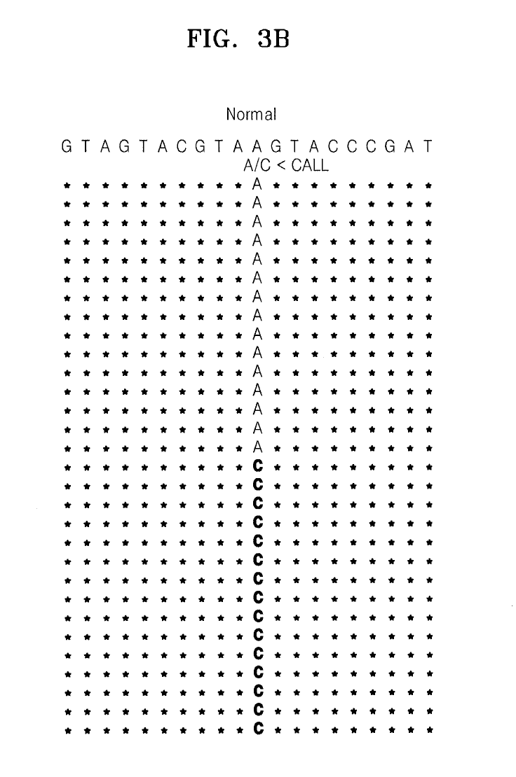

FIG. 3A illustrates sequence data of a genetic sample extracted from abnormal tissue (for example, cancer tissue), which is obtained by the data obtaining unit 110, according to an embodiment of the present invention. FIG. 3B illustrates sequence data of a genetic sample extracted from normal tissue, which is obtained by the data obtaining unit 110, according to an embodiment of the present invention.

First, referring to FIG. 3B, alleles are called ‘AC’ in thirty (30) pieces of sequence data that are aligned in an SNP site of the normal tissue. However, referring to FIG. 3A, alleles are called as only ‘A’ in 30 pieces of sequence data that are aligned in the same SNP site of the abnormal tissue.

That is, despite the same SNP site of the same tissue, the alleles of the abnormal tissue are called as alleles different from the alleles of the normal tissue. This is because the alleles are differently distributed in the aligned 30 pieces of sequence data. As described above, the reason for the difference is based on the characteristic of the LOH of the abnormal tissue.

According to the characteristic of the LOH of the abnormal tissue, it is expected that the alleles that are all called as ‘A’ exist in the 30 pieces of sequence data of the abnormal tissue shown in FIG. 3A. However, a small number of nucleotides C exist in the 30 pieces of sequence data of the abnormal tissue shown in FIG. 3A. As described above with reference to FIG. 2A, the reason why the nucleotides C exists in the 30 pieces of sequence data of the abnormal tissue is because the genetic sample of the abnormal tissue and the genetic sample of the normal tissue are not exactly classified such that the genetic sample of the abnormal tissue is contaminated by the genetic sample of the normal tissue.

Thus, if it is possible to recognize a distribution of alleles, which exist only in normal tissue, in each of SNP sites in which alleles are called as homo in a genetic sample of abnormal tissue, a contamination rate of the genetic sample of the abnormal tissue which is contaminated by a genetic sample of the normal tissue may be derived.

Referring back to FIG. 1, the gene analyzing unit 120 analyzes sequence distributions that respectively correspond to the abnormal tissue and the normal tissue of the genetic sample of the abnormal tissue, according to a distribution of alleles in each SNP site included in received sequence data.

The gene analyzing unit 120 analyzes the sequence distributions by using a characteristic of LOH that occurs in the abnormal tissue. In other words, the gene analyzing unit 120 analyzes the sequence distributions that respectively correspond to the abnormal tissue and the normal tissue, based on a probability that alleles included in only the normal tissue also exist in the abnormal tissue.

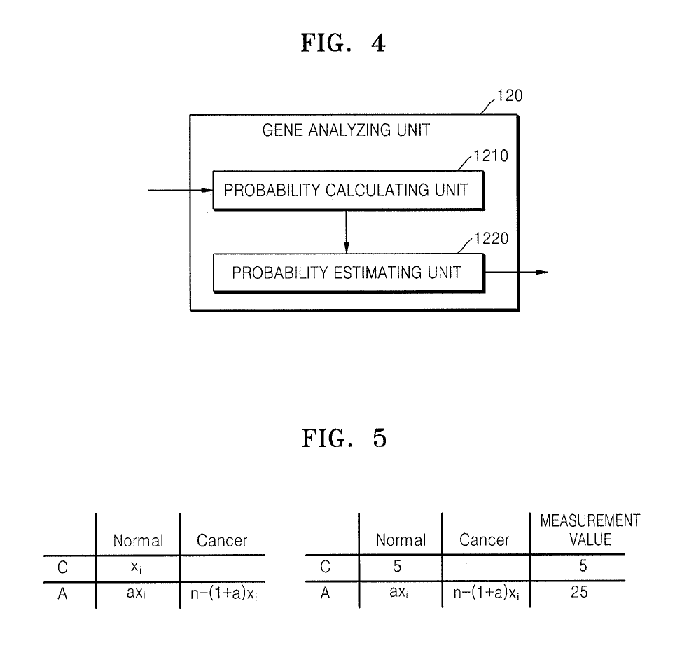

Further description will be provided with reference to FIG. 4.

FIG. 4 illustrates a detailed configuration of the gene analyzing unit 120, according to an embodiment of the present invention. Referring to FIG. 4, the gene analyzing unit 120 includes a probability calculating unit 1210 and a probability estimating unit 1220.

The probability calculating unit 1210 calculates a probability that alleles of normal tissue also exist in abnormal tissue. First, the probability calculating unit 1210 may calculate the probability by using a table for analysis of allele distribution, which is shown in FIG. 5.

FIG. 5 illustrates a table for analysis of allele distribution, which is used by the probability calculating unit 1210, according to an embodiment of the present invention. Referring to FIG. 5, the table is generated by using the sequence data of the abnormal tissue and the sequence data of the normal tissue, which are shown in FIGS. 3A and 3B.

In the table of FIG. 5, “n” indicates a total read count, “xᵢ” indicates a minor allele read count, and “a” indicates a multiple of an allele derived from the normal tissue.

Referring back to FIG. 4, the probability calculating unit 1210 calculates values of “n,” “xᵢ,” and “a” from the table of FIG. 5, based on the sequence data of the abnormal tissue and the sequence data of the normal tissue, which are shown in FIGS. 3A and 3B.

Next, the probability calculating unit 1210 calculates a probability that sequence data of the abnormal tissue with respect to an SNP site is contaminated, by using a binomial distribution probability density function, such as, for example, Equation 1 below.

P(X=(1+a)xᵢ|p)=ₙC₍₁₊ₐ₎ₓ_{ᵢ}p^{(1+a)x}^{ᵢ}(1−p)^{n-(1+a)x}^{ᵢ} [Equation 1]

“p” =rate of normal tissue read data in cancer tissue read data

Here, Equation 1 is only an example for convenience of description, and, in other embodiments, the probability calculating unit 1210 may use other probability density functions in addition to or in place of Equation 1.

As a result, the probability calculating unit 1210 calculates “p” with respect to each of SNP sites by using Equation 1, wherein “p” indicates the probability that alleles of normal tissue also exist in abnormal tissue.

The probability estimating unit 1220 estimates a value of an existence probability that represents all of the SNP sites, by using the probability that is calculated with respect to each of the SNP sites.

That is, the probability estimating unit 1220 estimates a maximum value of the existence probability that the alleles included in only the normal tissue also exist in the abnormal tissue in all of the SNP sites, based on the probability calculated with respect to each of the SNP sites.

For example, the probability estimating unit 1220 may estimate the existence probability that represents all of the SNP sites, by using a maximum likelihood estimation (MLE) method. However, in other embodiments, other algorithms in addition to the MLE method may also be used to estimate the existence probability representing all of the SNP sites, by using the probability that is calculated with respect to each of the SNP sites.

The probability estimating unit 1220 uses, for example, the MLE method in a manner described below.

First, the probability estimating unit 1220 calculates the probability with respect to each of the SNP sites by using Equation 2 that is similar to Equation 1, where the probability indicates a possibility that the alleles included in only the normal tissue also exist in the abnormal tissue.

f(xᵢ|p)=ₙC₍₁₊ₐ₎ₓ_{ᵢ}p^{(1+a)x}^{ᵢ}(1−p)^{n-(1+a)x}^{ᵢ} [Equation 2]

Next, the probability estimating unit 1220 estimates the maximum value of the existence probability that the alleles included in only the normal tissue also exist in the abnormal tissue in all of the SNP sites, by using Equation 3 and based on the probability “p” with respect to each of the SNP sites, which is calculated by using Equation 2.

$$f ( {x}_{1} , {x}_{2} , … , {x}_{n} \vert θ ) = f ( {x}_{1} \vert θ ) \cdot f ( {x}_{2} \vert θ ) … f ( {x}_{n} \vert θ ) . \\ ℒ ( θ \vert {x}_{1} , {x}_{2} , … , {x}_{n} ) = f ( {x}_{1} , {x}_{2} , … , {x}_{n} \vert θ ) = {\prod }_{i = 1}^{n} f ( {x}_{i} \vert θ ) . \\ ln ℒ ( θ \vert {x}_{1} , {x}_{2} , … , {x}_{n} ) = {\sum }_{i = 1}^{n} ln f ( {x}_{i} \vert θ ) , \\ \hat{θ} mle = {argmax}_{θ ∈ Θ} \hat{𝓁} ( θ \vert {x}_{1} , {x}_{2} , … , {x}_{n} ) . \qquad [ Equation 3 ]$$

When the probability estimating unit 1220 uses the MLE method, the probability estimating unit 1220 estimates a maximum probability \hat{θ}mle at the alleles included in only the normal tissue also exist in the abnormal tissue in all of the SNP sites, by using Equation 3.

Referring back to FIG. 1, the gene analyzing unit 120 estimates \hat{θ}mle that is the maximum probability that the alleles included in only the normal tissue also exist in the abnormal tissue in all SNP sites of a genetic sample of the abnormal tissue, and then analyzes a sequence distribution with regard to the genetic sample of the abnormal tissue.

The contamination rate determining unit 130 determines a contamination rate of the genetic sample of the abnormal tissue which is contaminated by a genetic sample of the normal tissue, by using a result of the analysis performed by the gene analyzing unit 120. That is, the contamination rate determining unit 130 determines the contamination rate of the genetic sample of the abnormal tissue which is contaminated by the genetic sample of the normal tissue, based on \hat{θ}mle that is the maximum probability estimated by the gene analyzing unit 120.

Thus, according to the present embodiment, although the genetic sample of the abnormal tissue is contaminated by including the genetic sample of the normal tissue, reliability or a degree of purity of the genetic sample of the abnormal tissue may be analyzed by using the contamination rate determined by the contamination rate determining unit 130 of the genetic information analyzing apparatus 10, so that it is possible to exactly analyze and diagnose the abnormal tissue such as cancer tissue, tumor tissue, and the like.

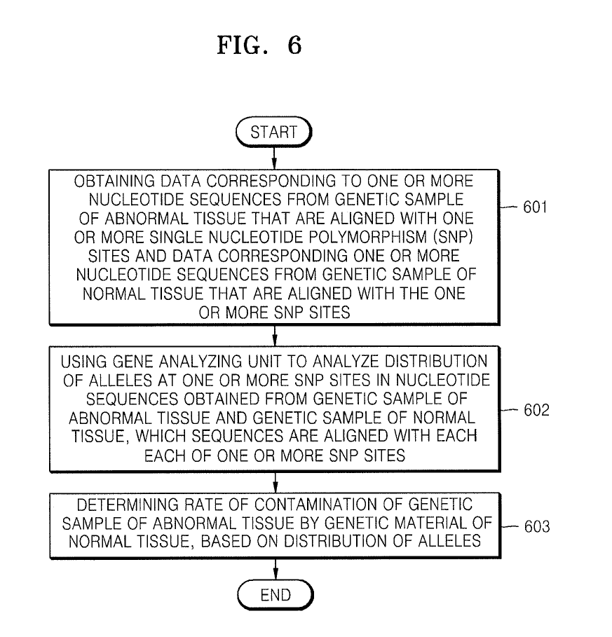

FIG. 6 is a flowchart of a method of analyzing genetic information of abnormal tissue, according to an embodiment of the present invention. Referring to FIG. 6, the method according to the present embodiment includes operations that are processed in chronological order by the genetic information analyzing apparatus 10 of FIG. 1. Thus, although some descriptions regarding the genetic information analyzing apparatus 10 of FIG. 1 that are given above are omitted here, these descriptions may also be applied to the method according to the present embodiment.

In operation 601, the data obtaining unit 110 obtains one or more pieces of sequence data, which are aligned in one or more SNP sites from genetic samples of abnormal tissue and normal tissue, respectively.

In operation 602, the gene analyzing unit 120 analyzes distributions of sequences (e.g., distributions of alleles in the sequences) that respectively correspond to the abnormal tissue and the normal tissue, which exist in the genetic sample of the abnormal tissue, based on a distribution of alleles in each of SNP sites included in the one or more pieces of obtained sequence data.

In operation 603, the contamination rate determining unit 130 determines a contamination rate of the genetic sample of the abnormal tissue which is contaminated by the genetic sample of the normal tissue, by using a result of the analysis.

As described above, according to the one or more of the above embodiments of the present invention, although the genetic sample of the abnormal tissue is contaminated by including the genetic sample of the normal tissue, a contamination rate of the genetic sample of the abnormal tissue which is contaminated by the genetic sample of the normal tissue may be exactly estimated by using a characteristic of the LOH that occurs in the abnormal tissue, so that reliability or a degree of purity of the genetic sample of the abnormal tissue may be exactly analyzed. Therefore, it is possible to exactly analyze and diagnose the abnormal tissue such as cancer tissue, tumor tissue, and the like.

The embodiments of the present invention may be written as computer programs and may be implemented in general-use digital computers that execute the programs using a computer readable recording medium. In addition, a data structure used in the embodiments of the present invention may be written in a computer readable recording medium through various means. Examples of the computer readable recording medium include magnetic storage media (e.g., ROM, floppy disks, hard disks, etc.), optical recording media (e.g., CD-ROMs, or DVDs), etc.

The use of the terms “a” and “an” and “the” and “at least one” and similar referents in the context of describing the disclosed subject matter (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or example language (e.g., “such as”) provided herein, is intended merely to better illuminate the disclosed subject matter and does not pose a limitation on the scope of the invention unless otherwise claimed. No language in the specification should be construed as indicating any non-claimed element as essential to the practice of the invention.

Variations of the embodiments disclosed herein may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of analyzing genetic information of abnormal tissue, the method comprising:
obtaining data corresponding to one or more nucleotide sequences from a genetic sample of abnormal tissue that are aligned with one or more single nucleotide polymorphism (SNP) sites, and data corresponding to one or more nucleotide sequences from a genetic sample of normal tissue that are aligned with the one or more SNP sites;
using a gene analyzing unit to analyze a distribution of alleles at the one or more SNP sites in the nucleotide sequences obtained from the genetic sample of the abnormal tissue and the genetic sample of the normal tissue, which sequences are aligned with each of the one or more SNP sites; and
determining a rate of contamination of the genetic sample of the abnormal tissue by genetic material of normal tissue, based on the distribution of alleles.

2. The method of claim 1, wherein analyzing the distribution of alleles comprises analyzing a characteristic of loss of heterozygosity (LOH) that occurs in the abnormal tissue.

3. The method of claim 1, wherein analyzing the distribution of alleles comprises calculating a probability that one or more alleles of the normal tissue also exist in the abnormal tissue.

4. The method of claim 1, wherein the one or more SNP sites are sites in which alleles of the abnormal tissue are homozygous, and alleles at the same SNP sites of the normal tissue are heterozygous.

5. The method of claim 4, wherein the one or more SNP sites are sites at which loss of heterozygosity (LOH) occurred in the abnormal tissue.

6. The method of claim 1, wherein the analyzing comprises:
for each of the one or more SNP sites, calculating a probability that the alleles of the normal tissue also exist in the abnormal tissue;
estimating an existence probability that represents all of the one or more SNP sites, by using the probability that is calculated with respect to each of the one or more SNP sites; and
analyzing the distributions of the sequences based on the estimated existence probability.

7. The method of claim 6, wherein the estimating comprises estimating a maximum value of the existence probability, which indicates a probability that the alleles comprised in the normal tissue coexist in the abnormal tissue at all of the one or more SNP sites.

8. The method of claim 6, wherein the estimating comprises estimating the existence probability that represents all of the one or more SNP sites, by using a maximum likelihood estimation (MLE) method.

9. The method of claim 1, wherein the data corresponding to one or more nucleotide sequences from a genetic sample of abnormal tissue includes the same number of sequences that are aligned with one or more single nucleotide polymorphism (SNP) sites as the data corresponding to one or more nucleotide sequences from a genetic sample of normal tissue.

10. The method of claim 1, wherein the abnormal tissue comprises a cancer cell or a tumor cell.

11. The method of claim 1, wherein the abnormal tissue and the normal tissue the same type of tissue obtained from a common examinee.

12. A non-transitory computer-readable storage medium, having recorded thereon a program that when executed causes a computer system to analyze genetic information by the method of claim 1.

13. An apparatus for analyzing genetic information of abnormal tissue, the apparatus comprising:
a data obtaining unit for obtaining data corresponding to one or more nucleotide sequences from a genetic sample of abnormal tissue that are aligned with one or more single nucleotide polymorphism (SNP) sites, and data corresponding to one or more nucleotide sequences from a genetic sample of normal tissue that are aligned with the one or more SNP sites;
a gene analyzing unit for analyzing a distribution of alleles at the one or more SNP sites in the nucleotide sequences obtained from the genetic sample of the abnormal tissue and the genetic sample of the normal tissue, which sequences are aligned with each of the one or more SNP sites; and
a contamination rate determining unit for determining a rate of contamination of the genetic sample of the abnormal tissue by genetic material from normal tissue based on the distribution of alleles.

14. The apparatus of claim 13, wherein the gene analyzing unit analyzes the distributions of alleles by analyzing a characteristic of loss of heterozygosity (LOH) that occurs in the abnormal tissue.

15. The apparatus of claim 13, wherein the gene analyzing unit analyzes the distributions of alleles based on a probability that alleles included in the normal tissue also exist in the abnormal tissue.

16. The apparatus of claim 13, wherein the one or more SNP sites are sites in which alleles of the abnormal tissue are homozygous, and alleles of the normal tissue heterozygous.

17. The apparatus of claim 16, wherein the one or more SNP sites are sites at which LOH occurred in the abnormal tissue.

18. The apparatus of claim 13, wherein the gene analyzing unit comprises:
a probability calculating unit for calculating, for each of the one or more SNP sites, a probability that the alleles comprised of the normal tissue also exist in the abnormal tissue; and
a probability estimating unit for estimating an existence probability that represents all of the one or more SNP sites, by using the probability that is calculated with respect to each of the one or more SNP sites,
wherein the gene analyzing unit analyzes the distributions of the sequences based on the estimated existence probability.

19. The apparatus of claim 18, wherein the probability estimating unit estimates a maximum value of the existence probability, which indicates a probability that the alleles of the normal tissue coexist in the abnormal tissue at all of the one or more SNP sites.

20. The apparatus of claim 13, wherein the data corresponding to one or more nucleotide sequences from a genetic sample of abnormal tissue includes the same number of sequences that are aligned with one or more single nucleotide polymorphism (SNP) sites as the data corresponding to one or more nucleotide sequences from a genetic sample of normal tissue.


SEQUENCE LISTING (1 sequence)

SEQ ID NO: 1 - DNA, 20 bp, Artificial Sequence
  Synthetic
gtagtacgtaagtacccgat